(19) United States
(12) Patent Application Publication
(10) Pub. No.: US 2024/0334415 A1
(43) Pub. Date: Oct. 3, 2024

(54) BEAM MANAGEMENT OF SL FR2

(71) Applicant: MediaTek Singapore Pte. Ltd., Singapore (SG)

(72) Inventors: Chenmeng Li, Beijing (CN); JU-QIANG CHENG, Beijing (CN); Tao Chen, Beijing (CN)

(21) Appl. No.: 18/616,341

(22) Filed: Mar. 26, 2024

(30) Foreign Application Priority Data
Mar. 30, 2023 (WO) PCT/CN2023/085191
Mar. 21, 2024 (CN) 202410333422.4

(51) Int. Cl. H04W 72/044; H04W 72/25; H04W 72/542

(52) U.S. Cl. CPC H04W 72/046; H04W 72/25; H04W 72/542

(57) ABSTRACT

In an aspect of the disclosure, a method, a computer-readable medium, and an apparatus are provided. The apparatus may be a UE. The UE transmits a plurality of reference signals (RSs) using a plurality of transmission beams on a sidelink. The UE receives a beam report from a second UE. The beam report indicates a selected transmission beam from the plurality of transmission beams. The beam report also indicates a selected reception beam of the second UE. The selected transmission beam and the selected reception beam are based on measurements of the transmitted RSs. The UE establishes a sidelink communication with the second UE using the selected transmission beam and the selected reception beam on the sidelink.

### CROSS-REFERENCE TO RELATED APPLICATION(S)

This application claims the benefits of PCT Application Number PCT/CN2023/085191, entitled “METHODS FOR BEAM MANAGEMENT OF SL FR2” and filed on Mar. 30, 2023, which is expressly incorporated by reference herein in its entirety.

### BACKGROUND

### Field

The present disclosure relates generally to communication systems, and more particularly, to techniques of beam management of a sidelink in frequency range 2 (FR2).

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE transmits a plurality of reference signals (RSs) using a plurality of transmission beams on a sidelink. The UE receives a beam report from a second UE. The beam report indicates a selected transmission beam from the plurality of transmission beams. The beam report also indicates a selected reception beam of the second UE. The selected transmission beam and the selected reception beam are based on measurements of the transmitted RSs. The UE establishes a sidelink communication with the second UE using the selected transmission beam and the selected reception beam on the sidelink.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating sidelink (SL) communications between UEs.

FIG. 8 is a diagram illustrating an initial beam paring procedure between a transmitting (Tx) UE and a receiving (Rx) UE on a sidelink.

FIG. 9 is a diagram illustrating a resource grid for initial beam pairing.

FIG. 10 is a diagram illustrating a beam burst pattern.

FIG. 11 is a diagram illustrating beam burst pattern options.

FIG. 12 is a flow chart of a method for conducting initial beam paring.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

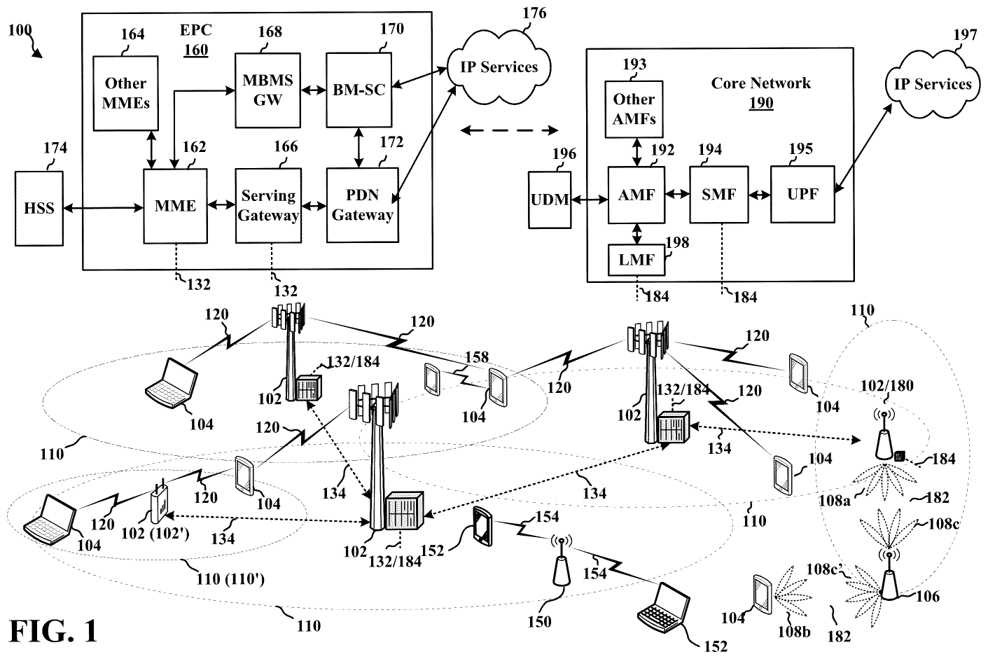

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHZ, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

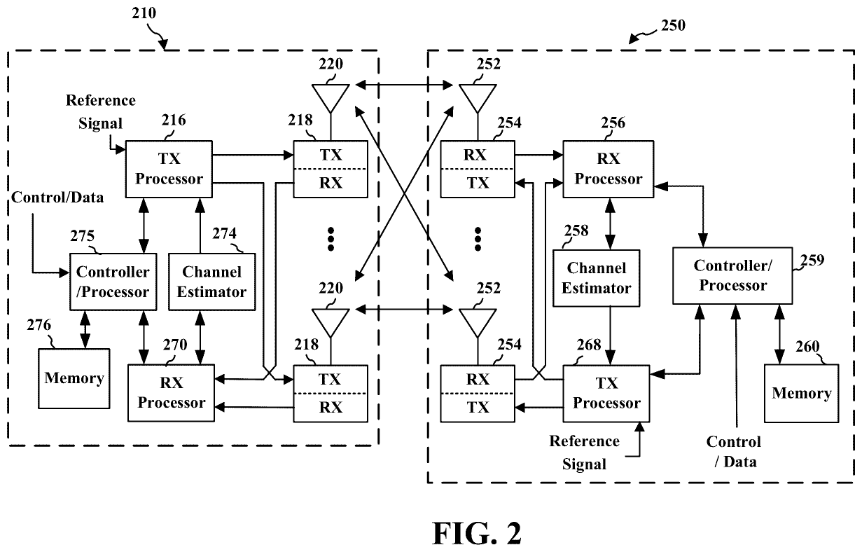

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate mapping matching, onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

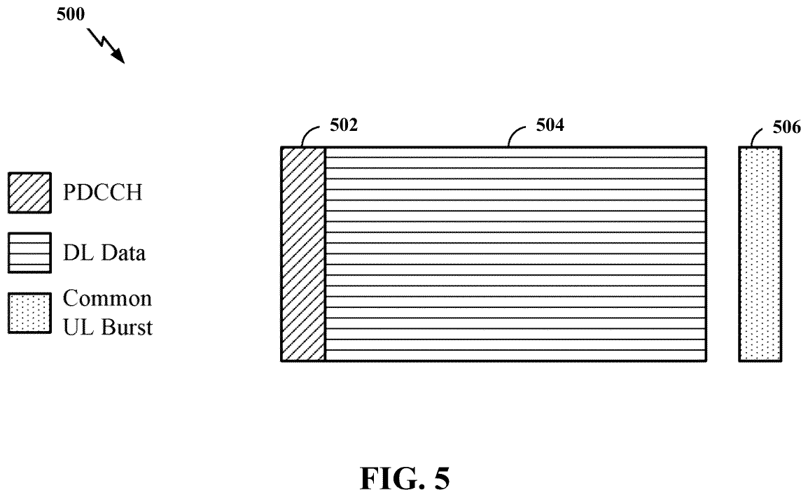

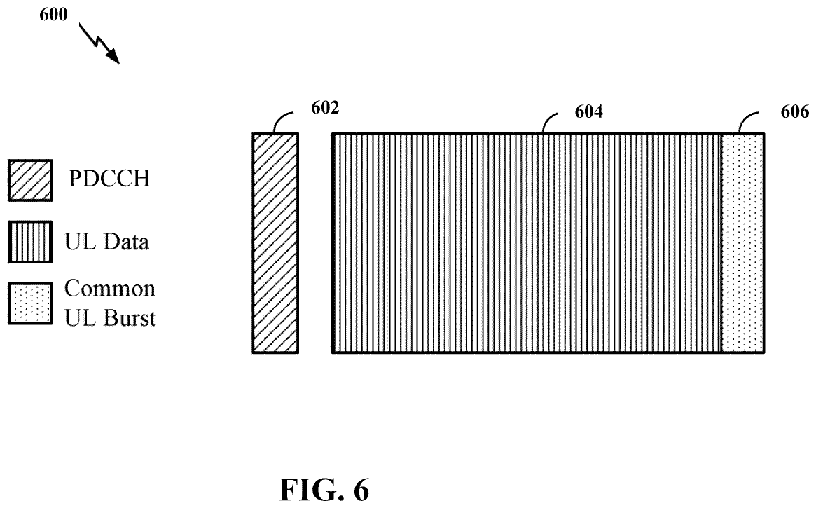

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

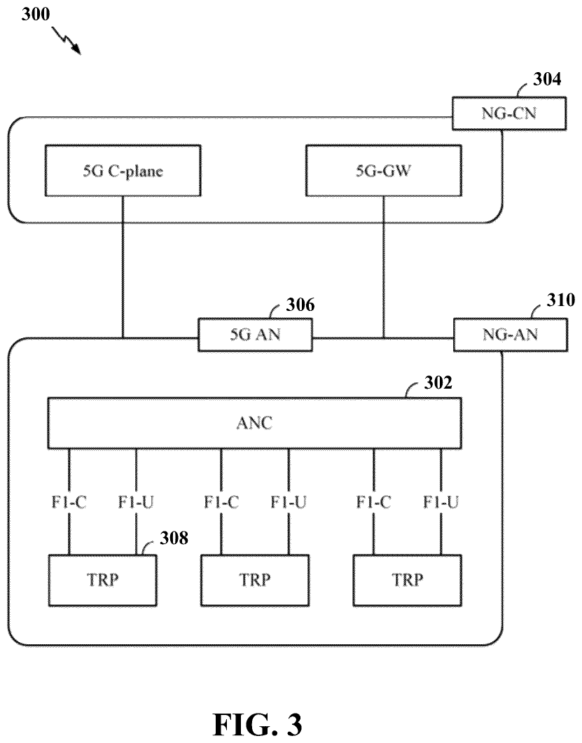

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

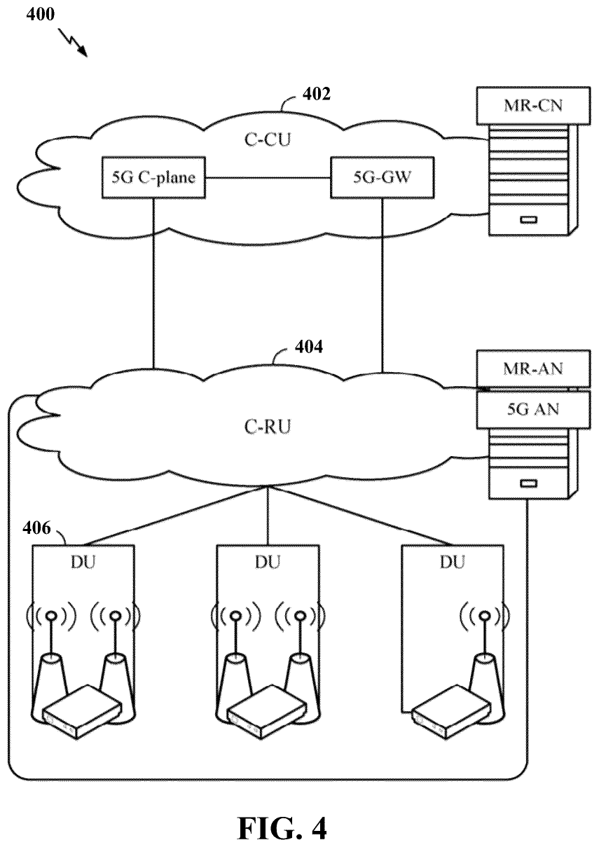

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

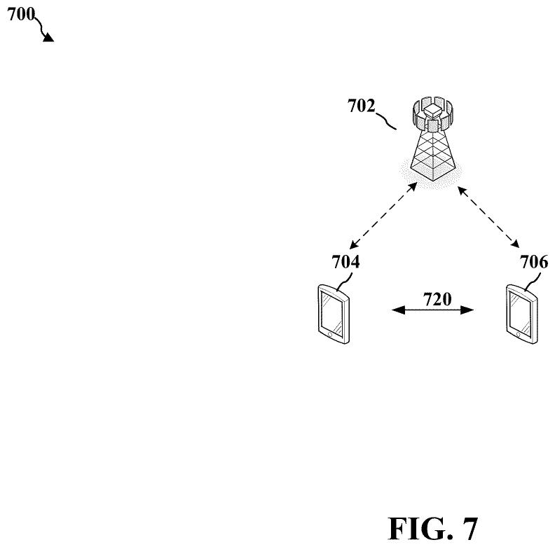

FIG. 7 is a diagram illustrating sidelink (SL) communications between UEs. In this example, a UE 704 and a UE 706 may establish a sidelink 720. In certain configurations, the establishment of the sidelink 720 and the communications on the sidelink 720 may be assisted by a base station 702. Each of the UE 704 and the UE 706 may have a structure similar to that of the UE 250.

In NR sidelink (SL), the concept of beam has not been discussed for FR2. In the legacy NR SL, the S-SSB is only for synchronization purpose and is only transmitted by a sync reference UE. Furthermore, only aperiodic channel state information (CSI) request is allowed in the legacy NR SL. These limitations necessitate the design of a reliable beam management method for SL in FR2, which includes initial beam pairing (IBP), beam maintenance (BM), and beam failure recovery (BFR).

Currently, SL is only defined for FR1, where a UE has only one omnidirectional beam. However, in FR2, a UE has multiple beams that cannot be simultaneously transmitted. Therefore, when establishing the sidelink 720 between the UE 704 and the UE 706, a new beam management procedure needs to be designed for SL in FR2. This procedure may involve the base station 702 assisting in the establishment and communications on the sidelink 720.

The beam management procedure for SL in FR2 requires the design of new signals and reporting schemes. The IBP procedure aims to find the best or an adequate beam pair for the UE 704 and the UE 706 before establishing the sidelink 720. This involves the UE 704 transmitting reference signals (RS), such as CSI-RS, DMRS, or SSB, using different beams. The UE 706 then measures the received signal power, such as RSRP, for each beam and selects the best beam pair based on the measurements. The UE 706 reports the selected beam information to the UE 704, allowing both UEs to establish the sidelink 720 using the optimal beam pair.

The link establishment procedure on a sidelink, such as the sidelink 720 between the UE 704 and the UE 706, is similar to the discovery process in LTE. The sidelink communication occurs directly between UEs without necessarily involving a base station or network, such as the base station 702. The UE 704 sends a discovery message or direct communication request message using a Physical Sidelink Control Channel (PSCCH) or Physical Sidelink Shared Channel (PSSCH). Other UEs, such as the UE 706, receive this message and obtain information about the services the UE 704 can provide or requires. If the receiving UE, such as the UE 706, decides to establish a connection with the UE 704, it sends a feedback message, also using PSCCH or PSSCH.

The time and frequency domain resources for these messages may be preconfigured, and the UEs will specifically look for messages in these resources. Synchronization in the time and frequency domains may be achieved through previous communication with base stations, other synchronization reference UEs, or GNSS.

The Initial Beam Pairing (IBP) process involves the transmission of reference signals (RS) such as CSI-RS, DMRS, or modified S-SSB by the UE 704 using different beams. The UE 706 measures these signals, selecting the beam pair that provides the best signal quality, typically based on Received Signal Received Power (RSRP) measurements. This selection is then reported back to the UE 704, allowing both UEs to align their beams optimally for the established sidelink 720.

The IBP process can occur simultaneously with the reception of the discovery message. The reference signals (RS), such as DMRS or CSI-RS, are sent along with the link establishment message in the PSCCH or PSSCH. The receiving UE, having already received the discovery message and knowing the location of the PSCCH and PSSCH, can then detect and measure these reference signals.

The DMRS or CSI-RS are typically contained within the PSCCH and PSSCH in time and frequency domains. The receiving UE, such as the UE 706, detects the link establishment message by first detecting the first Sidelink Control Information (SCI) and then the second SCI. These SCIs may also contain information about the configuration of the reference signals, allowing the receiving UE to further detect the RS within the PSSCH and determine their location.

The link is considered established when the UEs have established an RRC connection. The discovery and beam pairing processes occur before the RRC connection when the UEs have already found the discovery message and know the location of the PSCCH and other channels.

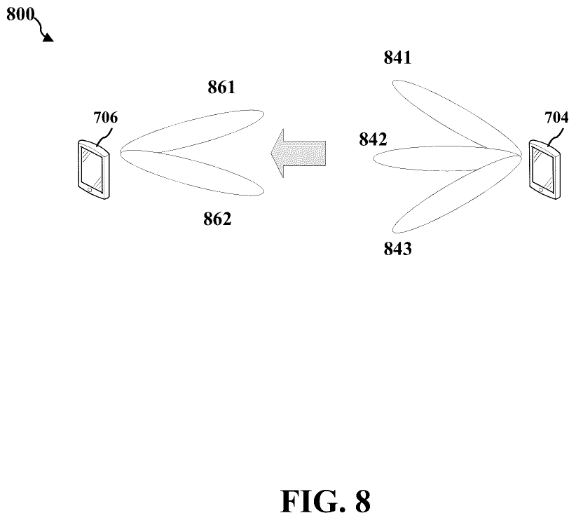

FIG. 8 is a diagram 800 illustrating an initial beam paring procedure between a transmitting (Tx) UE and a receiving (Rx) UE on a sidelink. In this example, the UE 704 is a Tx UE and forms transmission beams 841, 842, and 843 to transmit signals on the sidelink 720. The UE 706 is a Rx UE and forms reception beams 861 and 862 to receive signals on the side link 720.

The Initial Beam Pairing (IBP) procedure aims to find the best or an adequate quality beam pair for the UE 704 and the UE 706 to communicate on the sidelink 720. The UE 704 (Tx UE in this example) transmits reference signals (RSs), such as CSI-RS, DMRS, or SSB, using its different transmission beams 841, 842, and 843. Each beam may have a different beam direction.

The UE 706 (Rx UE in this example) receives the transmitted RSs on different beams and measures their Received Signal Received Power (RSRP) or other relevant metrics. The UE 706 detects the reference signals for each of the UE 704's transmission beams. Based on the RSRP measurements, the UE 706 determines the most suitable transmission beam from the transmission beams 841, 842, 843 of the UE 704. The UE 706 also determines which of its own reception beams 861 or 862 to use for establishing the connection with the UE 704.

After completing the measurements and beam selection, the UE 706 sends a beam report to the UE 704. This report informs the UE 704 about the measurements results, the suitable transmission beam, and/or the suitable reception beam determined by the UE 706.

The UE 704 receives the report and accordingly selects an optimal transmission beam and reception beam pair for communications between the UE 704 and the UE 706 on the side link 720. The base station 702 may assist in the establishment and communications on the sidelink 720, depending on the configuration.

Before link establishment between the UE 704 and the UE 706 for the side link 720, no communication link exists between the UEs. This is similar to an idle state, and the UE 704 and the UE 706 cannot exchange information to configure reference signals for beam management.

During link establishment between the UE 704 and the UE 706 for the side link 720, the UEs are in the process of establishing the communication link between the UEs. The UE 704 and the UE 706 exchange messages, such as discovery messages and feedback messages, using channels PSCCH and PSSCH. These messages can carry information for configuring reference signals, enabling their use for beam management.

Before link establishment between the UE 704 and the UE 706 for the sidelink 720, in a first configuration, the UE 704 may transmit a non-standalone CSI-RS for IBP. A non-standalone CSI-RS is embedded within other physical channels, such as PSCCH and PSSCH. It relies on the configuration of the host channel for its transmission. Accordingly, the UE 704 and the UE 706 both may implement a same method to dynamically determine the configuration of the non-standalone CRI-RS. Further, the UE 704 and the UE 706 may be pre-configured with the configurations of the non-standalone CRI-RS.

In a second configuration, the UE 704 may transmit a standalone CSI-RS for IBP. A standalone CSI-RS has its own dedicated physical channel or is signaled on a dedicated resource, and does not depend on other channels for transmission. The UE 704 and the UE 706 may be preconfigured with the configuration and structure definition of the standalone CRI-RS. The existing NR sidelink does not have a standalone CSI-RS.

In a third configuration, the UE 704 may transmit a modified S-SSB for IBP. This is because the existing S-SSB can only be transmitted by a sync reference UE and not by all UEs.

In a fourth configuration, the UE 704 may transmit PSCCH/PSSCH DMRS for IBP. DMRSs are present within the PSCCH and PSSCH and may be utilized for IBP.

These reference signals can be transmitted by the UE 704 using its transmission beams 841, 842, and 843. The UE 706 can then receive these signals using its reception beams 861 and 862, and perform measurements to determine the optimal beam pair for establishing the sidelink 720.

During link establishment between the UE 704 and the UE 706 for the sidelink 720, the reference signals for IBP can be DMRS and/or CSI-RS within PSCCH and/or PSSCH.

When CSI-RS is used as the reference signal for IBP during link establishment, the first SCI transmitted by the UE 704 can be used to configure the CSI-RS. This can be achieved by introducing a new bit field, denoted as bit field A, within the first SCI. Bit field A carries specific CSI-RS information about the CSI-RS configuration, such as CSI-RS pattern and CSI-RS trigger. CSI-RS pattern indicates the specific pattern of the CSI-RS sequence to be used. CSI-RS trigger specifies the timing or event that triggers the transmission of the CSI-RS.

Further, another one-bit field, denoted as bit field B, can be included in the first SCI to indicate the presence of bit field A. This allows the UE 706 to determine whether CSI-RS configuration information is present and needs to be decoded.

Alternatively, the bit field B indicates the presence of the specific CSI-RS information, and the specific CSI-RS information may be carried in a pre-configured channel/resource or in the channel/resource indicated by bit field A.

The UE 704 can transmit the SCI to the UE 706 during link establishment using the PSCCH. The time and frequency domain location for transmitting the SCI can be pre-configured or determined based on a predefined rule known to both the UE 704 and the UE 706. This allows the UE 706 to monitor the correct time and frequency domain location for receiving the SCI.

Similarly, the time and frequency domain location of the DMRS in PSCCH and PSSCH can be pre-configured or determined based on a predefined rule known to both the UE 704 and the UE 706. This enables both UEs to know where to transmit and receive the DMRS for beam measurements during the IBP procedure.

By utilizing the first SCI to configure and indicate the presence of CSI-RS, and by having predefined rules for the location of SCI and DMRS, the UE 704 and the UE 706 can efficiently perform beam measurements and establish the optimal beam pair for communication on the sidelink 720 during the link establishment phase.

After link establishment between the UE 704 and the UE 706 for the sidelink 720, the UEs are in RRC Connected Mode. In this mode, the reference signals for IBP can be DMRS, CSI-RS, and/or Phase Tracking Reference Signal (PTRS) within PSCCH, PSSCH, and/or Physical Sidelink Feedback Channel (PSFCH).

The CSI-RS information for IBP after link establishment may be configured or pre-configured, for example, through the PC5-RRC interface, instead of being carried and indicated by the SCI. This is because the UEs are already in RRC Connected Mode and have established a communication link.

Alternatively, the pre-configured PSFCH resource carrying CSI-RS/PTRS/DMRS can also be used for initial beam pairing after link establishment. The PSFCH is a physical channel used for transmitting feedback information, such as HARQ-ACK, on the sidelink. By pre-configuring the PSFCH resource, the UE 704 and the UE 706 can use this resource for exchanging beam-related information and performing beam measurements for IBP.

Since the UEs are in RRC Connected Mode after link establishment, there may be no need to design new configuration methods for the reference signals used in IBP. The existing configuration methods can be utilized for configuring the reference signals for IBP after link establishment.

In certain scenarios, the UE 704 may not have sufficient data to transmit alongside the reference signals (RSs) required for initial beam pairing (IBP). This can occur when the UE 704 has a small amount of data to transmit or when the IBP procedure requires a significant amount of resources. To address this issue, the UE 704 can utilize dummy data or repeated data from previous transmissions to accompany the RSs.

Dummy data refers to data that does not carry any meaningful information and is solely used to fill the transmission resources required for carrying the RSs. As such, the UE 706 may receive and measure the RSs even when the UE 704 has no actual data to transmit.

Repeated data involves re-transmitting data that was previously sent to the UE 706. This can be useful when the UE 704 has already transmitted some data but needs to perform IBP to improve the beam alignment. By repeating the previously transmitted data, the UE 704 may provides the UE 706 sufficient information to receive and measure the RSs while also providing additional opportunities for the UE 706 to decode the data if needed.

The selection of resources for transmitting dummy data or repeated data follows the same resource selection procedure as for regular data transmissions.

By utilizing dummy data or repeated data, the UE 704 can perform IBP even when it has limited data to transmit.

In the Initial Beam Pairing (IBP) procedure, the UE 704 and the UE 706 aim to find the optimal beam pair for communication on the sidelink 720. In the example of FIG. 8, this process involves the UE 704 transmitting reference signals (RSs) using its transmission beams 841, 842, and 843, and the UE 706 receiving these signals using its reception beams 861 and 862.

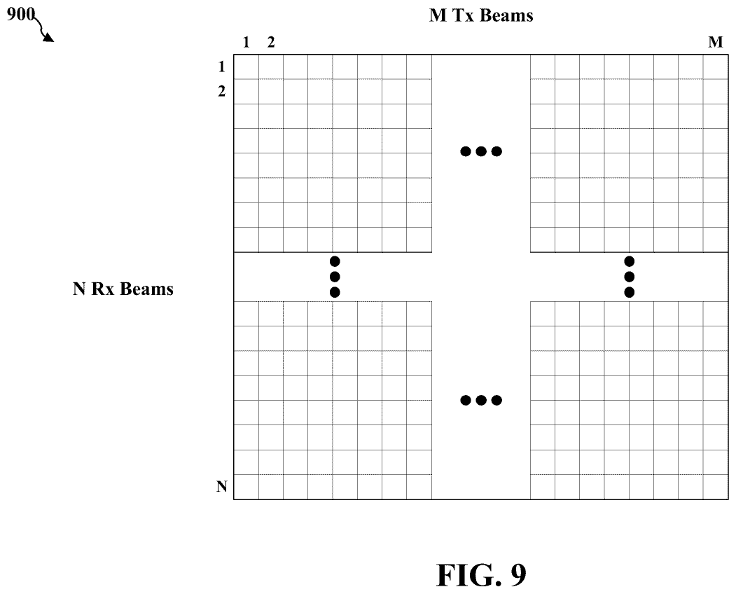

FIG. 9 is a diagram illustrating a resource grid 900 for IBP. The overall resources need to be allocated for the IBP procedure can be viewed as the resource grid 900. M columns of the resource grid 900 corresponds to the M transmission beams utilized by the UE 704. N rows of the resource grid 900 corresponds to the N reception beams utilized by the UE 706. An element in the m^{th} column and the n^{th} of the resource grid 900 corresponds to a resource in time and frequency domain for the UE 704 to transmit RSs on the m^{th} transmission beam and for the UE 706 to measure the RSS on the n^{th} reception beam. The IBP requires a total of M×N transmissions and measurements to complete the beam sweeping process. This entire process is referred to as a beam burst.

The resource grid 900 for IBP can be (pre-) configured and/or indicated. It may consist of 1 burst of transmission, including multiple rounds of beam sweeping, up to the number of beams of the UE 704 and/or the UE 706. For example, if the UE 704 has M transmission beams and the UE 706 has N reception beams, the UE 704 may have 1 burst of transmission including N rounds of beam sweeping (each sweeping goes through transmission beams 1 to M), and the UE 706 may have 1 burst of reception including M rounds of beam sweeping (each sweeping goes through the reception beams 1 to N) for the measurement of all beam pairs.

The resource reservation granularity of the beam burst may be indicated by Sidelink Control Information (SCI) or up to resource pool configuration. The burst boundary and burst grid can be (pre-) configured per resource pool, per Bandwidth Part (BWP), and/or per Component Carrier (CC). Time units (e.g., slots, symbols, etc.) equal to the beam number as a burst are to be a unit for resource allocation and alignment in the resource pool.

In the resource grid 900 for Initial Beam Pairing (IBP), the time unit used for each element may be a slot, a symbol, or other configured time period. This time unit represents the duration in which the UE 704 transmits reference signals (RSs) using one of its transmission beams (e.g., 841, 842, or 843), and the UE 706 measures these RSs using one of its reception beams (e.g., 861 or 862).

For example, if the time unit is a slot, the UE 704 transmits RSs using its first transmission beam 841 for one slot, while the UE 706 measures these RSs using its first reception beam 861 during the same slot. In the next slot, the UE 704 may continue transmitting RSs using its first transmission beam 841, while the UE 706 measures these RSs using its second reception beam 862.

Alternatively, if the time unit is a symbol, the UE 704 transmits RSs using its first transmission beam 841 for one symbol, while the UE 706 measures these RSs using its first reception beam 861 during the same symbol. In the next symbol, the UE 704 may continue transmitting RSs using its first transmission beam 841, while the UE 706 measures these RSs using its second reception beam 862.

The time unit used in the resource grid 900 can be (pre-) configured and/or indicated to the UE 704 and the UE 706, ensuring that both UEs have a common understanding of the time granularity for RS transmissions and measurements. Regardless of the chosen time unit (slot or symbol), the fundamental principle remains the same: the Tx UE transmits RSs on one beam at a time, and the Rx UE measures the RSs on one beam at a time. The resource grid 900 represents the resources required for this beam sweeping process, in which all beam pairs are measured and the optimal pair is identified for establishing the sidelink 720.

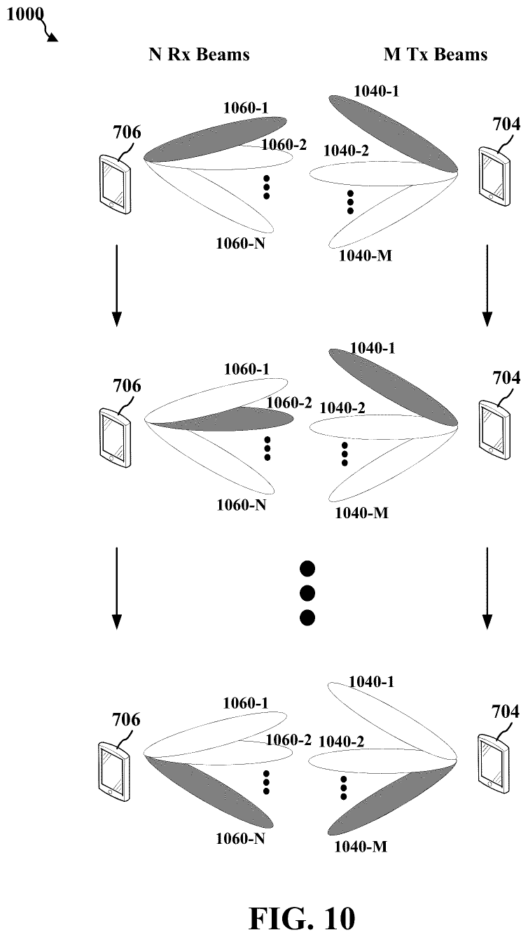

FIG. 10 is a diagram 1000 illustrating a beam burst pattern. In this example, the UE 704 forms M transmission beams 1040-1, 1040-2, . . . , 1040-M. The UE 706 forms N reception beams 1060-1, 1060-2, . . . , 1060-N. The UE 704 may transmit using its first beam (e.g., 1040-1) for N times, while the UE 706 performs beam sweeping with its N reception beams. Then, the UE 704 switches to its second beam (e.g., 1040-2) and transmits for another N times, while the UE 706 again performs beam sweeping with its N reception beams. This process continues until all M×N transmissions and measurements are completed.

The UE 704 may have a gap when switching from one transmission beam to another. However, the entire M×N process is still considered as one beam burst, as the complete beam sweeping is beneficial to obtain reliable IBP results.

To receive and/or decode discovery messages, one or more bursts may be used for IBP. If more than one burst is used, the first burst can be used for receiving and decoding the discovery message 1 or the first stage SCI, while the second burst can be used for receiving and decoding the discovery message 2 or the second stage SCI. The beam burst, consisting of M×N beam transmissions, is considered a unit for resource allocation and alignment in the resource pool. The entire IBP procedure is completed within the allocated resources, enabling the UE 704 and the UE 706 to establish the optimal beam pair for communication on the sidelink 720.

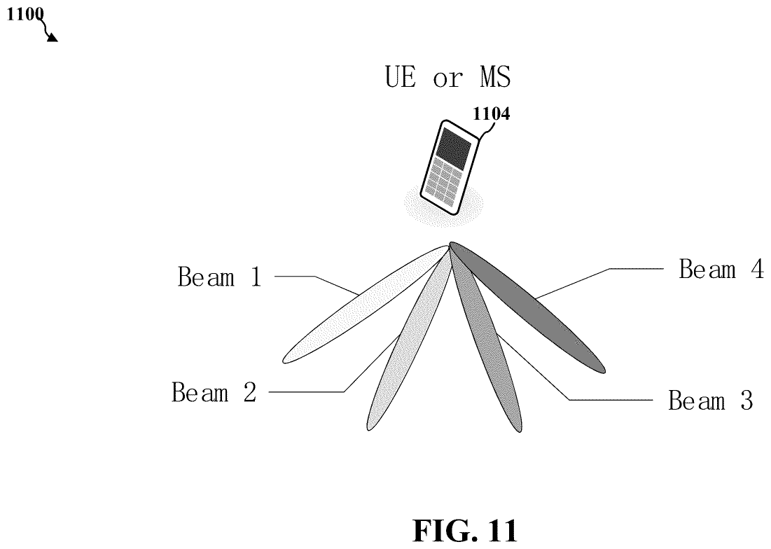

FIG. 11 is a diagram 1100 illustrating beam burst pattern options. In this example, a UE 1104 forms 4 beams: beam 1, beam 2, beam 3, and beam 4. When the UE 1104 is a Tx UE, the 4 beams are transmission beams. When the UE 1104 is a Rx UE, the 4 beams are reception beams. The UE 1104 may represent the UE 704 or the UE 706.

The UE 704 and the UE 706 can adopt several beam burst pattern options for initial beam pairing (IBP) on the sidelink 720. These options can be (pre-) configured and/or indicated, and can be applied separately for the UE 704 as the transmitter UE and the UE 706 as the receiver UE.

Option 1: Sequential Cycle Style. In this option, a UE sweeps its beams in a simple sequential cycle. For example, the UE 1104 is a Tx UE adopting this option, and transmits using beam 1, then beam 2, then beam 3, and finally beam 4 in one sweep. In the next sweep, the UE 1104 continue to transmit beam 1, then beam 2, then beam 3, and finally beam 4. Similarly, the Rx UE adopting this option sweeps through its reception beams (e.g., N beams) in a sequential order.

Option 2: Repeated Sweeping. In this option, the beam sweeping of a UE is repeated for each beam for a certain number of times. For instance, the UE 1104 is a Tx UE adopting this option, and transmits using beam 1 for N times, where N is the number of reception beams on the Rx UE. Then, it switches to beam 2 and transmits for another N times, and so on. For example, if N=3, the sequence of beam sweeping may be beam 1, beam 1, beam 1, beam 2, beam 2, beam 2, beam 3, beam 3, beam 3, beam 4, beam 4, beam 4, beam 1, beam 1, beam 1, and so on. This pattern allows the receiver UE to measure each beam of the transmitter UE multiple times, potentially improving the accuracy of the beam measurements.

Option 3: Cyclic Shift. In this option, the beam sweeping pattern of a UE follows a cyclic shift. For example, the UE 1104 is a Tx UE adopting this option, and transmits using beam 1, then beam 2, then beam 3, and finally beam 4. In the next cycle, it starts with beam 2, followed by beam 3, beam 4, and finally beam 1. In this pattern, each beam is swept in a different order in each cycle.

The choice of beam burst pattern can be pre-configured or indicated dynamically based on specific requirements and channel conditions. Factors such as the desired IBP speed, accuracy, and robustness can influence the selection. Additionally, the Tx UE and Rx UE can adopt different beam burst patterns independently, allowing for further optimization based on their individual capabilities and requirements.

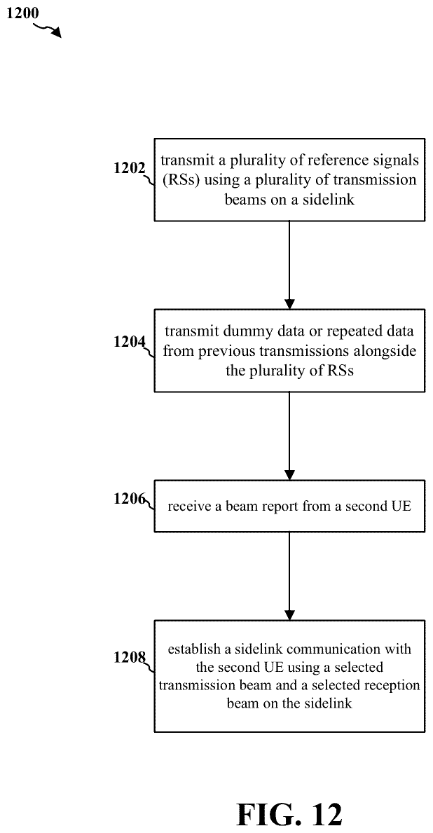

FIG. 12 is a flow chart 1200 of a method for conducting initial beam paring. The method may be performed by a UE (e.g., the UE 704). In operation 1202, the UE transmits a plurality of reference signals (RSs) using a plurality of transmission beams on a sidelink. The plurality of RSs may comprise at least one of a Channel State Information Reference Signal (CSI-RS), a Demodulation Reference Signal (DMRS), or a Synchronization Signal Block (SSB).

In certain configurations, the plurality of RSs are transmitted prior to the UE starting to establish a communication link with a second UE. In this case, the plurality of RSs may include a modified SSB or a CSI-RS. The CSI-RS may be a non-standalone CSI-RS. Alternatively, the CSI-RS may be a standalone CSI-RS, and the UE and the second UE are preconfigured with a configuration of the standalone CSI-RS.

In certain configurations, the plurality of RSs are transmitted during the UE establishing a communication link with the second UE. In this case, the plurality of RSs may include a DMRS or a CSI-RS. The plurality of RSs may be transmitted within a physical sidelink control channel (PSCCH) and a physical sidelink shared channel (PSSCH). In certain configurations, the plurality of RSs include a CSI-RS. The UE transmits sidelink control information (SCI) prior to transmitting the plurality of RSs. The SCI includes a first bit field indicating a configuration of the CSI-RS. In certain configurations, the SCI includes a second bit field indicating a presence of the first bit field.

In certain configurations, the UE transmits the RSs in a beam burst. The beam burst comprises one or more rounds of beam sweeping across the plurality of transmission beams. In certain configurations, a number of the one or more rounds of beam sweeping is based on a number of reception beams of the second UE. In certain configurations, a resource reservation granularity of the beam burst is indicated by sidelink control information (SCI) or preconfigured based on a resource pool configuration. In certain configurations, a burst boundary and a burst grid associated with the beam burst are preconfigured per at least one of a resource pool, a bandwidth part (BWP), or a component carrier (CC).

In certain configurations, the beam burst follows a beam burst pattern selected from a plurality of beam burst pattern options. The plurality of beam burst pattern options may include at least one of: a first option in which beam sweeping is performed in a sequential cycle; a second option in which beam sweeping is repeated for each beam for a certain number of times; or a third option in which beam sweeping is performed in a cyclic shift manner. In certain configurations, the beam burst pattern for the UE is selected independently from a beam burst pattern for the second UE.

In certain configurations, the beam burst comprises a number of beam transmissions equal to a product of a number of transmission beams and a number of reception beams. The beam burst may be considered a unit for resource allocation and alignment in a resource pool.

In certain configurations, the UE determines that there is insufficient data to transmit alongside the plurality of RSs. In operation 1204, the UE transmits dummy data or repeated data from previous transmissions alongside the plurality of RSs. In certain configurations, resources for transmitting the dummy data or the repeated data are selected based on a resource selection procedure associated with the dummy data or the repeated data transmissions.

In operation 1206, the UE receives a beam report from the second UE. The beam report indicates a selected transmission beam from the plurality of transmission beams and a selected reception beam of the second UE based on measurements of the transmitted RSs. In operation 1208, the UE establishes a sidelink communication with the second UE using the selected transmission beam and the selected reception beam on the sidelink.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a first user equipment (UE), comprising:
transmitting a plurality of reference signals (RSs) using a plurality of transmission beams on a sidelink;
receiving a beam report from a second UE, the beam report indicating a selected transmission beam from the plurality of transmission beams and a selected reception beam of the second UE based on measurements of the transmitted RSs; and
establishing a sidelink communication with the second UE using the selected transmission beam and the selected reception beam on the sidelink.

2. The method of claim 1, wherein the plurality of RSs comprises at least one of a Channel State Information Reference Signal (CSI-RS), a Demodulation Reference Signal (DMRS), or a Synchronization Signal Block (SSB).

3. The method of claim 1, wherein the plurality of RSs are transmitted prior to the first UE starting to establish a communication link with the second UE, wherein the plurality of RSs include a modified SSB or a CSI-RS.

4. The method of claim 3, wherein the CSI-RS is a non-standalone CSI-RS.

5. The method of claim 3, wherein the CSI-RS is a standalone CSI-RS, and wherein the first UE and the second UE are preconfigured with a configuration of the standalone CSI-RS.

6. The method of claim 1, wherein the plurality of RSs are transmitted during the first UE establishing a communication link with the second UE, wherein the plurality of RSs include a DMRS or a CSI-RS.

7. The method of claim 6, wherein the plurality of RSs are transmitted within a physical sidelink control channel (PSCCH) and a physical sidelink shared channel (PSSCH).

8. The method of claim 6, wherein the plurality of RSs include a CSI-RS, the method further comprising:
transmitting sidelink control information (SCI) prior to transmitting the plurality of RSs, wherein the SCI includes a first bit field indicating a configuration of the CSI-RS.

9. The method of claim 8, wherein the SCI includes a second bit field indicating a presence of the first bit field.

10. The method of claim 1, wherein transmitting the plurality of RSs comprises transmitting the RSs in a beam burst, the beam burst comprising one or more rounds of beam sweeping across the plurality of transmission beams.

11. The method of claim 10, wherein a number of the one or more rounds of beam sweeping is based on a number of reception beams of the second UE.

12. The method of claim 10, wherein a resource reservation granularity of the beam burst is indicated by sidelink control information (SCI) or preconfigured based on a resource pool configuration.

13. The method of claim 10, wherein a burst boundary and a burst grid associated with the beam burst are preconfigured per at least one of a resource pool, a bandwidth part (BWP), or a component carrier (CC).

14. The method of claim 10, wherein the beam burst follows a beam burst pattern selected from a plurality of beam burst pattern options.

15. The method of claim 14, wherein the plurality of beam burst pattern options include at least one of:
a first option in which beam sweeping is performed in a sequential cycle;
a second option in which beam sweeping is repeated for each beam for a certain number of times; or
a third option in which beam sweeping is performed in a cyclic shift manner.

16. The method of claim 14, wherein the beam burst pattern for the first UE is selected independently from a beam burst pattern for the second UE.

17. The method of claim 10, wherein the beam burst comprises a number of beam transmissions equal to a product of a number of transmission beams and a number of reception beams.

18. The method of claim 17, wherein the beam burst is considered a unit for resource allocation and alignment in a resource pool.

19. The method of claim 1, further comprising:
determining that there is insufficient data to transmit alongside the plurality of RSs; and
transmitting dummy data or repeated data from previous transmissions alongside the plurality of RSs.

20. An apparatus for wireless communication, the apparatus being a first user equipment (UE), comprising:
a memory; and
at least one processor coupled to the memory and configured to:
transmit a plurality of reference signals (RSs) using a plurality of transmission beams on a sidelink;
receive a beam report from a second UE, the beam report indicating a selected transmission beam from the plurality of transmission beams and a selected reception beam of the second UE based on measurements of the transmitted RSs; and
establish a sidelink communication with the second UE using the selected transmission beam and the selected reception beam on the sidelink.
